(19) United States
(12) Patent Application Publication
(10) Pub. No.: US 2010/0203258 A1
(43) Pub. Date: Aug. 12, 2010

(54) PROCESS FOR THE CORROSION PROTECTION TREATMENT OF METAL SURFACES

(75) Inventor: Rainer Stricker, Gundelfingen (DE)

Correspondence Address: Briscoe, Kurt G.;Norris McLaughlin & Marcus, PA, 875 Third Avenue, 8th Floor, New York, NY, 10022, US

(73) Assignee: TESA SE, Hamburg (DE)

(21) Appl. No.: 12/669,620

(22) PCT Filed: Jul. 1, 2008
(86) PCT No.: PCT/EP08/58420

§ 371 Date: Apr. 26, 2010

(30) Foreign Application Priority Data
Jul. 20, 2007 (DE) 102007034473.4
Oct. 30, 2007 (DE) 102007052069.9

(51) Int. Cl. C08F 2/48; B05D 3/02

(52) U.S. Cl. 427/508; 427/372.2

(57) ABSTRACT

Process for the corrosion protection treatment of metal surfaces, in particular at edges and transitions of the metal components, characterized in that a self-adhesive composition is applied to the metal surface and the self-adhesive composition is heated so that the self-adhesive composition is melted onto the metal surface and thus forms a corrosion protection layer.

The present invention relates to a process for the corrosion protection treatment of metal surfaces, having the features of the preamble of claim 1, and also to the use of a self-adhesive composition for the corrosion protection treatment of metal surfaces.

Metal components are used in a variety of sectors. In those sectors they are subjected to a very wide range of different weathering conditions, and so often a corrosion protection treatment is required. For this purpose, especially for application of a corrosion protection layer to the whole area of metal components, there are various known processes. DE 10 2006 006 910 B3, for example, discloses a process in which a corrosion protection layer is applied to the metal surfaces to be protected, in the form of a zinc lamellae coating. The zinc lamellae coating is applied by means of a dipping or spraying process. In another process known from the prior art, a corrosion protection treatment is performed by immersing the metal surfaces into a cathodically depositable electrodeposition coating material (DE 10 2005 059 314 A1). A feature common to the two aforementioned processes is that the corrosion protection layer is applied to a relatively large area, more particularly the whole area, of the metal surface to be treated.

Particularly in the automotive industry, however, there is a need to provide small areas as well, namely the surface of edges and transitions of metal components, with protection from corrosion, by means of a corrosion protection layer. For this purpose, in general, a fine seam sealant is applied manually or by means of a robot. Material used for the fine seam is typically pumpable PVC. This material is sprayed locally onto the metal surface and then spread smoothly using a brush. With this process, which is suitable in principle for edges and transitions, it is difficult to produce the fine seam with the optical quality necessary in vehicle construction. Instead, the surface often remains rough, and a nonuniform application is perceptible to the naked eye.

The present invention is therefore based on the problem of specifying a process for the corrosion protection treatment of metal surfaces that can be carried out without great cost and complexity and in particular can also be used for protecting edges and transitions of metal components.

The problem indicated above is solved, in a process for the corrosion protection treatment of metal surfaces, having the features of the preamble of claim 1, by the features of the characterizing clause of claim 1. A solution of equal standing is represented by the use of a self-adhesive composition in accordance with claim 16. Advantageous embodiments and developments are subject matter of the respective dependent claims.

In accordance with the invention it has first been recognized that self-adhesive compositions, when appropriately treated, form a good corrosion protection layer on metal surfaces and accordingly are suitable for corrosion protection treatment. In tests it was found, moreover, that smooth surfaces can be formed by means of suitable self-adhesive compositions. Smooth surfaces of this kind have a uniform surface structure to a viewer with the naked eye, and are planar. The use of a self-adhesive composition to form a corrosion protection layer on metal surfaces is particularly advantageous on account of the ease of handling. By virtue of the self-adhesive effect, the composition can be applied particularly easily to the surfaces and pre-attached there prior to further operating steps. In addition, a composition of this kind is particularly suitable for application to small areas.

In the process of the invention the self-adhesive composition is applied to the metal surface in question and is then heated. The self-adhesive composition is a composition of the kind which melts by heating; in other words, on heating, it is distributed over the metal surface, where it forms a closed corrosion protection layer. Because it is a self-adhesive composition which ultimately forms the corrosion protection layer, application may take place very easily, not least also at edges and transitions between different metal components. The tack of this composition allows preliminary attachment before, by heating, the corrosion protection layer is formed. Furthermore, the self-adhesive composition may also be applied uniformly to small areas, which with conventional processes, such as the spray application of coating material, for example, is possible only with difficulty and by means of further auxiliaries, such as temporary protective films.

In particular it has been found that, on selection of a suitable self-adhesive composition, the corrosion protection layer is formed with a substantially smooth surface; in other words, to a viewer, the surface of the corrosion protection layer is of uniform and planar formation.

Adhesives used are preferably those based on block copolymers. These block copolymers comprise polymer blocks predominantly formed from vinylaromatics (A blocks), preferably styrene, and polymer blocks predominantly formed by polymerization of 1,3-dienes (B blocks), preferably butadiene and isoprene. Both homopolymer and copolymer blocks can be utilized in accordance with the invention. Resulting block copolymers may comprise like or different B blocks, which may be partly, selectively or fully hydrogenated. Block copolymers may have a linear A-B-A structure. It is likewise possible to employ block copolymers of radial architecture, and also star-shaped and linear multiblock copolymers. Further components present may be A-B diblock copolymers. Block copolymers of vinylaromatics and isobutylene can likewise be employed in accordance with the invention. All of the aforementioned polymers may be utilized alone or in a mixture with one another.

Particular preference is given to adhesives which are crosslinkable. Crosslinking takes place preferably in the form of thermal crosslinking during the melting of the self-adhesive composition. However, beam crosslinking or other crosslinking methods can also be employed. As a result of the crosslinking, the self-adhesive composition becomes substantially less sensitive to high temperatures, and so the self-adhesive composition is then no longer able to melt. More particularly the crosslinking thus allows the use of self-adhesive compositions which per se, on account of their deficient temperature stability, could not be employed as a productive—that is, permanent—component.

The crosslinking may take place, as described, in different ways. On the one hand, the crosslinking may occur, during or after the melting of the self-adhesive composition, by radiation, either by UV beams or with the aid of electron beams. As described in the literature, the cohesive properties of pressure-sensitive adhesives based on styrene block copolymers can be improved at high temperatures if the polymers are subjected to radiation crosslinking in the elastomer part. Although the majority of styrene block copolymers comprise polyisoprene or polybutadiene as elastomer blocks, and there is therefore a large number of double bonds present, the majority of these elastomers, on account of their low molar mass, require a very high irradiation dose in order to attain sufficiently high cohesion. Therefore, special styrene block copolymers have been developed which are particularly easy to crosslink by means of UV or electron beams. Particularly suitable for crosslinking are systems which possess a very high molar mass and/or those containing a high level of 1,2-linked dienic monomer units in the elastomer block. Kraton Polymers offers such special polymers for radiation crosslinking, one being Kraton DKX 222, a radial (SB)₂B₂ with 1,2-linked polybutadiene present in the elastomer part, and another being Kraton D 1320, a high molecular mass, star-shaped styrene-isoprene block copolymer. In the case of radiation crosslinking, the crosslinking may be enhanced by means of promoters such as certain acrylates or mercaptans; see WO 2005/110737. In the case of UV crosslinking, it is necessary to add crosslinking promoters.

Crosslinking by thermal energy, i.e., during the melting of the self-adhesive composition, can be accomplished, for example, through the use of phenolic resins or of sulfur and the corresponding crosslinking auxiliaries.

Through the use of vinylaromatic block copolymers with grafted-on maleic anhydride groups, examples being those sold under the name Kraton FG 1901 or Kraton FG 1924 by Kraton, it is also possible for crosslinking to take place via these groups. In this case it is possible to make use as crosslinkers on the one hand of epoxy resins as described in DE 102004007259 and on the other hand of metal chelates, as described in DE 10361540.

Crosslinking of vinylaromatic block copolymers with epoxide groups, sold by Daicel under the name Epofriend, may be accomplished, for example, with acid anhydrides (DE 102004007258).

The pressure-sensitive adhesive preferably has a fraction of 20% to 70% by weight of styrene block copolymer, preferably 30% to 60% by weight, and more preferably 35% to 55% by weight.

Self-adhesive compositions which can be used in accordance with the invention utilize as tackifiers, as principal component, particularly tackifying resins which are compatible with the elastomer block of the vinylaromatic block copolymers. Those of preferred suitability include the following: unhydrogenated, partly hydrogenated or fully hydrogenated resins based on rosin and rosin derivatives, hydrogenated polymers of dicyclopentadiene, unhydrogenated, partially, selectively or fully hydrogenated hydrocarbon resins based on C-5, C-5/C-9 or C-9 monomer streams, polyterpene resins based on α-pinene and/or β-pinene and/or δ-limonene, hydrogenated polymers of preferably pure C-8 and C-9 aromatics. Aforementioned tackifying resins can be used both alone and in a mixture.

Further additives which can typically be utilized include the following:
primary antioxidants, such as sterically hindered phenols, for example
secondary antioxidants, such as phosphites or thioethers, for example
in-process stabilizers, such as C-radical scavengers, for example
light stabilizers, such as UV absorbers or sterically hindered amines, for example
processing auxiliaries
endblock reinforcer resins
fillers, such as, for example, silicon dioxide, glass (ground or in the form of beads), aluminum oxides, zinc oxides, calcium carbonates, titanium dioxides, carbon blacks, etc., and also color pigments and dyes, and also optical brighteners
optionally further polymers, preferably elastomeric in nature; elastomers which can be utilized accordingly include, among others, those based on pure hydrocarbons, examples being unsaturated polydienes, such as natural or synthetically produced polyisoprene or polybutadiene, chemically substantially saturated elastomers, such as, for example, saturated ethylene-propylene copolymers, α-olefin copolymers, polyisobutylene, butyl rubber, ethylene-propylene rubber, and also chemically functionalized hydrocarbons, such as, for example, halogen-containing, acrylate-containing or vinyl ether-containing polyolefins, to name only a few
plasticizers, such as, for example, liquid resins, plasticizer oils or low molecular mass liquid polymers, such as, for example, low molecular mass polybutenes having molar masses<1500 g/mol (number average).

The pressure-sensitive tack of the self-adhesive composition may optionally be brought about only through thermal activation or through solvent activation.

The melting of the self-adhesive composition ought to take place only at not less than 90° C., preferably at not less than 110° C., more preferably at not less than 130° C. The minimum temperature required in each case is determined by the specific constitution of the self-adhesive composition. This temperature ought on the one hand to be selected as high as possible, so that the self-adhesive composition has the maximum stability on storage, but on the other hand the temperature ought not to be too high, so that melting can be carried out with the maximum of energy optimization, and so that other components used, for example, in a motor vehicle body are not subjected to excessively high temperatures. Consequently, an appropriate maximum temperature has been found to be a temperature of not more than 200° C., preferably of not more than 180° C., more preferably of not more than 160° C. for the melting of the self-adhesive composition.

In order, moreover, to make the application of the self-adhesive composition as simple as possible, it ought to have a relatively high elasticity. This elasticity indicates the percentage of the original stretch to which the adhesive relaxes after having been stretched under standard conditions to 200 percent and then released again, this value being determined after a waiting time of thirty seconds. The self-adhesive composition ought in particular to have an elasticity of at least 80%, preferably of at least 100%.

The self-adhesive composition used ought, moreover, to be a carrier-free adhesive. A carrier-free adhesive is an adhesive which has no permanent carrier, such as a polymer film or a nonwoven. Instead, the self-adhesive composition, in a preferred embodiment, is applied merely to a liner, in other words to a material which serves only temporarily for the support and greater ease of applicability of the self-adhesive composition. After the self-adhesive composition has been applied to the metal surface, the liner is then removed. In contrast to the self-adhesive composition, therefore, the liner is not a productive component. The carrier-free adhesive that then remains can be melted particularly easily, without likelihood of adverse effects from a carrier material.

The self-adhesive composition ought to be applied with a layer thickness of at least 50 μm, preferably of at least 100 μm, more preferably of at least 200 μm, to the metal surface. Moreover, the layer thickness ought to be not more than 750 μm, preferably not more than 600 μm, more preferably not more than 400 μm. Selecting such a layer thickness ensures that, on the one hand, the metal surface is sufficiently covered when the self-adhesive composition is melted, and, on the other, that the layer thickness of the corrosion protection layer does not become too great.

In operational terms it is advantageous to select an adhesive which can be coated after the melting operation; in other words, an adhesive to which coating material, as used in the automobile industry, for example, adheres sufficiently. If such an adhesive is used, then the corrosion protection layer itself can be coated after the melting operation. An alternative possibility to this is to apply a further layer, in the form, for example, of an additional film, to the corrosion protection layer. This additional layer can then be coated. A particularly suitable further layer is a polyethylene terephthalate film and also a polyester film. The thickness of such layers is situated preferably in a range from about 20 μm to about 100 μm.

Particularly in the sector of the automobile industry it is often necessary to apply corrosion protection layers manually, in other words by hand, to the metal surface. In the present case this is done by applying the self-adhesive composition manually to the metal surface and subjecting it subsequently to a corresponding heating operation. In this case it is particularly important that the self-adhesive composition is unaffected by health concerns; in other words, that it poses no health hazard to the worker when handling the adhesive. Handling, therefore, does not in particular necessitate any further protective measures, such as respiratory protection, secured and/or chilled storage or the like.

For the application it has emerged as being particularly suitable if the self-adhesive composition is first wound onto a roll and is applied from that roll to the metal surface. The worker is then able to remove lengths of the self-adhesive composition in accordance with requirements. In order to allow the self-adhesive composition to be wound onto a roll, it is typically covered on one side with a liner. The liner allows the self-adhesive composition to be unwound easily from the roll, and so facilitates handling.

The present invention further provides for the use of a self-adhesive composition for the corrosion protection treatment of metal surfaces. The self-adhesive composition is more particularly formed and selected in accordance with the features described above. Furthermore, after the melting operation, the adhesive ought to have a very high temperature stability, in order to allow as many as possible different fields of use of the corrosion protection treated metal surfaces. It is intended in particular that the adhesive, after the melting operation, should be temperature-stable down to −5° C., preferably down to −15° C., more preferably down to −30° C. Moreover, the adhesive, after the melting operation, ought also to be temperature-stable up to 70° C., preferably up to 80° C., more preferably up to 100° C.

In the text below, the invention is elucidated in more detail with reference to an example, without thereby subjecting the invention to any restriction.

### EXAMPLE 1

As a self-adhesive composition, a PowerStrip® composition, of the kind available commercially from tesa AG, having a thickness of 300 μm, is adhered over the edge of two cathodically electrocoated metal panels.

These panels were subsequently heated together with the self-adhesive composition for 40 minutes at approximately 170° C. This heating caused the self-adhesive composition to melt onto the metal surface, forming a corrosion protection layer. After the metal panels had cooled, the corrosion protection layer exhibited a smooth surface. The panel edge between the two metal panels remained perceptible, but the surface of the original PowerStrip® adhesive was smooth and had no immediately visible defects.

The metal panels were then exposed to different ambient conditions. For this purpose, the temperature was varied in alternation between about −5° C. and 70° C. In the course of this exposure, the elasticity of the original PowerStrip® composition was largely retained, thereby reducing the risk of delamination of the corrosion protection layer.

In addition a coating test was performed, and showed that the PowerStrip® composition could be coated immediately after the melting operation.

### EXAMPLE 2

The self-adhesive composition used was a composition whose formula was as follows:

| | | |
|---|---|---|
| 100 | parts of Kraton D 1165 | (styrene-isoprene-styrene |
| | | block copolymer with 30% |
| | | styrene content from Kraton) |
| 100 | parts of Pentalyn HE | (pentaerythritol ester of |
| | | rosin, partly hydrogenated, |
| | | having a softening point by |
| | | the ring and ball method of |
| | | approximately 110° C., from |
| | | Eastman) |
| 5 | parts of Ondina G 41 | (medical white oil from |
| | | Shell) |
| 0.5 | part of Irganox 1010 | (phenolic antioxidant from |
| | | Ciba) |

This self-adhesive composition was again adhered over the edge of two cathodically electrocoated metal panels, with a layer thickness of 300 μm.

Subsequently the panels were heated together with the self-adhesive composition for 40 minutes at approximately 170° C. Here again, this heating caused the self-adhesive composition to melt onto the metal surface, forming a corrosion protection layer. After the metal panels had cooled, the corrosion protection layer exhibited a smooth surface. The panel edge between the two metal panels remained perceptible; the surface of the original adhesive was smooth and showed no visible defects.

To test the corrosion resistance, the metal panels were again exposed to different ambient conditions. The temperature was varied in alternation between about −5° C. and 70° C. Here as well, after a number of temperature cycles, there was no apparent deterioration in the quality of the corrosion protection layer.

1. A process for the corrosion protection treatment of metal surfaces, particularly at edges and transitions of the metal components, comprising applying a self-adhesive composition to the metal surface followed by heating the self-adhesive composition such that the self-adhesive composition is melted onto the metal surface to form a corrosion protection layer.

2. The process of claim 1, wherein the self-adhesive composition, on melting, forms a substantially smooth surface.

3. The process of claim 1, wherein the self-adhesive composition is based on block copolymers.

4. The process of claim 1, wherein the self-adhesive composition is crosslinked thermally, by UV irradiation or by means of electron beams.

5. The process of claim 3, wherein the self-adhesive composition has a fraction of 20% to 70% by weight of styrene block copolymer, based on the total adhesive.

6. The process of claim 1, wherein the self-adhesive composition comprises a tackifier comprising tackifying resins as principal component.

7. The process of claim 1, wherein the self-adhesive composition is melted at not less than 90° C.

8. The process of claim 7 wherein the self-adhesive composition is melted at not more than 200° C.

9. The process of claim 1, wherein the self-adhesive composition has an elasticity of at least 80%.

10. The process of claim 1, wherein the self-adhesive composition of is carrier-free.

11. The process of claim 1, wherein the self-adhesive composition has a layer thickness of at least 50 μm and not more than 750 μm.

12. The process of claim 1 wherein the corrosion protection layer itself is coated after the melting operation or in that a further coatable layer is applied to the corrosion protection layer and said further layer is then coated.

13. The process of claim 1 wherein the self-adhesive composition is applied manually to the metal surface.

14. (canceled)

15. The process of claim 1 wherein the self-adhesive composition is applied to the metal surface from a roll, from which a length is removed in accordance with requirements.

16. (canceled)

17. (canceled)

18. (canceled)

19. The process of claim 7 wherein the self-adhesive composition is melted at not less than 130° C.

20. The process of claim 5 wherein the self-adhesive composition has a fraction of 35% to 55% by weight of styrene block copolymer, based on the total adhesive.

21. The process of claim 8 wherein the self-adhesive composition is melted at not more than 160° C.
